(19) United States
(12) Patent Application Publication
(10) Pub. No.: US 2006/0093890 A1
(43) Pub. Date: May 4, 2006

(54) Fuel cell stack compression systems, and fuel cell stacks and fuel cell systems incorporating the same

(76) Inventor: Matthew P. Steinbroner, Bend, OR (US)

Correspondence Address: KOLISCH HARTWELL, P.C., 200 PACIFIC BUILDING, 520 SW YAMHILL STREET, PORTLAND, OR, 97204, US

(21) Appl. No.: 11/261,363

(22) Filed: Oct. 28, 2005

Related U.S. Application Data
(60) Provisional application No. 60/623,156, filed on Oct. 29, 2004.
(60) Provisional application No. 60/630,710, filed on Nov. 23, 2004.

(51) Int. Cl. H01M 8/24; H01M 8/10

(52) U.S. Cl. 429/37; 429/32

(57) ABSTRACT

Fuel cell stack compression systems, and fuel cell stacks and fuel cell systems containing the same. The compression systems include banded, framed, and/or segmented compression systems. In some embodiments, the compression systems include at least one compressive band that extends around the end plates and fuel cells, such as in a closed loop. In some embodiments, the banded compression systems include a force-directing structure, compressive inserts, and/or band positioning mechanisms. In some embodiments, the compression systems include a frame into which the stacks' end plates and cells are positioned and with which at least one end plate may be integrated. The frame includes a compression mechanism, which may be an adjustable compression mechanism and/or include one or more jacking members and/or a compression plate. In some embodiments the compression systems include toothed, or striated, segments that interconnect the end plates and retain the plates in compression with ratcheting lock assemblies.

### RELATED APPLICATIONS

The present application claims priority to U.S. Provisional Patent Applications Ser. Nos. 60/623,156 and 60/630,710, which were filed on Oct. 29, 2004 and Nov. 23, 2004, respectively, and the complete disclosures of which are hereby incorporated by reference herein for all purposes.

### FIELD OF THE DISCLOSURE

The present disclosure relates generally to fuel cell stacks, and more particularly to compression systems for fuel cell stacks, and to fuel cell stacks and fuel cell systems utilizing the same.

### BACKGROUND OF THE DISCLOSURE

Fuel cell stacks are electrochemical devices that produce an electric current from a proton source and an oxidant. Many conventional fuel cell stacks utilize hydrogen gas as the proton source and oxygen, air, or oxygen-enriched air as the oxidant. Fuel cell stacks typically include many fuels cells that are fluidly and electrically coupled together between common end plates. Each fuel cell includes anode and cathode regions that are separated by an electrolytic membrane. Hydrogen gas is delivered to the anode region, and oxygen gas is delivered to the cathode region. Protons from the hydrogen gas are drawn through the electrolytic membrane to the anode region, where water is formed. Conventionally, the anode and cathode regions are periodically purged to remove water and accumulated gases in the regions. While protons may pass through the membranes, electrons cannot. Instead, the electrons that are liberated by the passing of the protons through the membranes travel through an external circuit to form an electric current. The fuel cell stack receives flows of hydrogen and air and distributes these flows to the individual stacks. Proper operation of the fuel cell stack requires that the fuel cell stack maintains effective seals between the fuel cells, components of the fuel cells, and the flow conduits.

Conventionally, seals are formed by the inclusion of rigid tie rods that pass through a series of bores in the end plates. By threading bolts or other fasteners on the ends of the tie rods, compressive forces are applied between the end plates and to the fuel cells to provide seals between the various regions of the fuel cells and the various components of the fuel cell stacks. In addition to extending through the end plates, the tie rods may also extend through portions of the individual fuel cells or around the outer perimeters of the fuel cells. For example, see U.S. Pat. Nos. 5,484,666 and 6,057,053, the complete disclosures of which are hereby incorporated by reference for all purposes. To provide sufficient compression, the end plates and tie rods must be sufficiently thick and rigid. For example, upon sufficient tightening of the tie rods to provide the necessary compressive forces to the fuel cell stack, the end plates may be deformed or deflected proximate the tie rods unless the thickness of the end plates is sufficient to withstand these forces. A result of this conventional compression system is that the end plates and tie rods add considerable weight to the fuel cell stack, in addition to any cost and/or size implications of this compression system.

### SUMMARY OF THE DISCLOSURE

The present disclosure is directed to fuel cell stacks that include compression systems that do not require tie rods that extend through the end plates of the stack to provide sufficient compression to the fuel cell stack, namely, to compress the plurality of fuel cells within the stack between the stack's end plates. This compression may, for example, provide seals between the fuel cells in the stack and/or reduced electrical resistance (and/or increased electrical conduction) through the stack. The stack compression systems are free from tie rods that extend through the end plates of the stack to compress the fuel cells together, and instead include banded, framed, and/or segmented, or ratcheting, compression systems. In some embodiments, the compression system includes at least one compressive band that extends around the end plates and the fuel cells in the stack, such as in a closed loop, to provide compression thereto. In some embodiments, the banded compression system includes at least one of a force-directing structure, compressive inserts, and positioning mechanisms for the bands. In some embodiments, the compression system includes a frame into which the fuel cell stack's end plates and cells are positioned and with which at least a portion of the end plates may be integrated. The frame includes a compression mechanism that compresses the fuel cells within the frame. In some embodiments, the compression mechanism is an adjustable compression mechanism. In some embodiments, the compression mechanism includes one or more jacking members. In some embodiments, the compression mechanism includes engagement heads and/or a compression plate. In some embodiments, the compression system includes a plurality of elongate toothed and/or striated segments that interconnect the end plates of the fuel cell stack to apply and/or maintain compression that sealingly compresses the fuel cells between the end plates. The segments include and/or are adapted to be received into lock assemblies that are adapted to permit insertion of an end region of the segments in one direction while restricting withdrawal thereof in an opposed direction. The segments may include opposed end regions and a plurality of sequentially spaced-apart teeth, or other suitable engagement surfaces, that are adapted to be sequentially engaged by the lock assemblies, which may include a ratcheting pawl, detent, or other suitable lock member.

### BRIEF DESCRIPTION OF THE DRAWINGS

FIG. 1 is a schematic view of a fuel cell stack constructed according to the present disclosure.

FIG. 2 is a schematic view of a fuel cell system that includes a fuel cell stack according to the present disclosure.

FIG. 3 is a schematic view of a proton exchange membrane fuel cell.

FIG. 4 is a schematic fragmentary view of a plurality of fuel cells, as may be used in fuel cell stacks according to the present disclosure.

FIG. 5 is an exploded schematic view of a fuel cell, as may be used in fuel cell stacks according to the present disclosure.

FIG. 6 is an isometric view of an illustrative fuel cell stack with a banded compression system constructed according to the present disclosure.

FIG. 7 is an isometric view of the illustrative fuel cell stack of FIG. 6 with another banded strap compression system constructed according to the present disclosure.

FIG. 8 is a fragmentary isometric view of the illustrative fuel cell stack of FIG. 6 with another stack compression system constructed according to the present disclosure.

FIG. 9 is a fragmentary isometric view of the illustrative fuel cell stack of FIG. 6 with another stack compression system constructed according to the present disclosure.

FIG. 10 is a fragmentary isometric view of the illustrative fuel cell stack of FIG. 6 with another stack compression system constructed according to the present disclosure.

FIG. 11 is a fragmentary isometric view of the illustrative fuel cell stack of FIG. 6 with another stack compression system constructed according to the present disclosure.

FIG. 12 is a fragmentary isometric view of the illustrative fuel cell stack of FIG. 6 with another stack compression system constructed according to the present disclosure.

FIG. 13 is a fragmentary isometric view of the illustrative fuel cell stack of FIG. 6 with another stack compression system constructed according to the present disclosure.

FIG. 14 is a schematic elevation view of a strap assembly that may be used with stack compression assemblies according to the present disclosure.

FIG. 15 is a schematic elevation view of another strap assembly that may be used with stack compression assemblies according to the present disclosure.

FIG. 16 is a schematic elevation view of another strap assembly that may be used with stack compression assemblies according to the present disclosure.

FIG. 17 is a schematic elevation view of another strap assembly that may be used with stack compression assemblies according to the present disclosure.

FIG. 18 is a fragmentary side elevation view of another strap assembly that may be used with stack compression assemblies according to the present disclosure.

FIG. 19 is a fragmentary side elevation view of another strap assembly that may be used with stack compression assemblies according to the present disclosure.

FIG. 20 is a schematic side elevation view of another compression system constructed according to the present disclosure.

FIG. 21 is a schematic elevation view of another strap assembly that may be used with stack compression assemblies according to the present disclosure.

FIG. 22 is a schematic elevation view of another strap assembly that may be used with stack compression assemblies according to the present disclosure.

FIG. 23 is a schematic side elevation view of another compression system constructed according to the present disclosure.

FIG. 24 is a schematic side elevation view of another compression system constructed according to the present disclosure.

FIG. 25 is an isometric view of an illustrative fuel cell stack with a framed compression system constructed according to the present disclosure.

FIG. 26 is an isometric view of another illustrative fuel cell stack with a framed compression system constructed according to the present disclosure.

FIG. 27 is a fragmentary side elevation view of another illustrative fuel cell stack with a framed compression system constructed according to the present disclosure.

FIG. 28 is a fragmentary side elevation view of another illustrative fuel cell stack with a framed compression system constructed according to the present disclosure.

FIG. 29 is a fragmentary side elevation view of another illustrative fuel cell stack with a framed compression system constructed according to the present disclosure, with a compression mechanism schematically illustrated.

FIG. 30 is an isometric view of a fuel cell stack that includes a segmented compression system constructed according to the present disclosure.

FIG. 31 is a fragmentary, partial schematic view of another suitable segmented compression system constructed according to the present disclosure, with the compression system being shown used and/or integrated with the end plates of a fuel cell stack also being illustrated.

FIG. 32 is a fragmentary, partial schematic view of another suitable segmented compression system constructed according to the present disclosure, with the compression system being shown used and/or integrated with the end plates of a fuel cell stack also being illustrated.

FIG. 33 is a fragmentary side elevation view of another suitable construction for a segmented compression system constructed according to the present disclosure.

### DETAILED DESCRIPTION AND BEST MODE OF THE DISCLOSURE

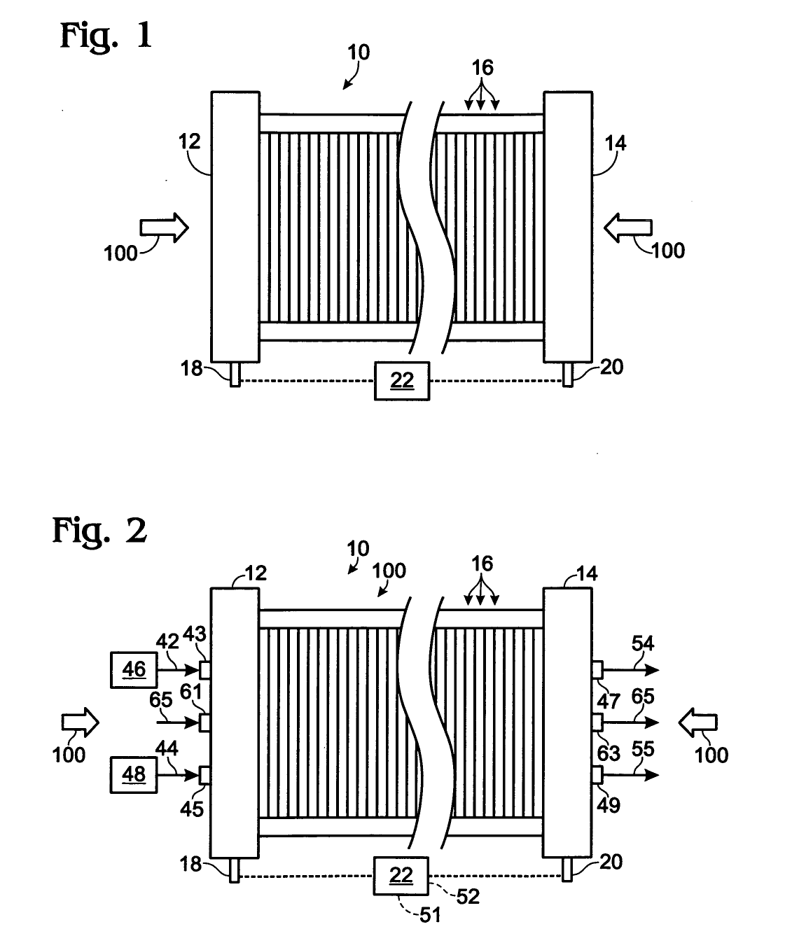

FIG. 1 schematically depicts a fuel cell stack 10 constructed according to the present disclosure. Stack 10 includes end plates 12 and 14 positioned on opposite ends of the stack. Stack 10 also includes a plurality of fuel cells, or fuel cell assemblies, 16, which are physically arranged between end plates 12 and 14. Each cell is individually configured to convert fuel and an oxidant into an electric current. The fuel cells are electrically coupled in series, although it is within the scope of the disclosure to couple the cells in parallel or in a combination of series and parallel. When electrically coupled, the cells collectively provide an electric potential dependent on the configuration of the stack. For example, if all cells of the fuel cell stack are electrically coupled in series, the electrical potential provided by the stack is the sum of the cells' respective potentials. Therefore, if each fuel cell produces 0.6 volts, then a stack having ten cells in series would have an output of 6 volts, a stack with 100 cells would have a power output of 60 volts, etc. Stack 10 is shown with positive contact 18 and negative contact 20, across which a load 22 may be electrically coupled. It should be understood that contacts 18 and 20 have been schematically depicted in FIG. 1 and may be accessible from a variety of locations. Similarly, the number of fuel cells 16 in any particular stack may vary, such as depending upon the desired power output of the fuel cell stack.

As schematically illustrated in FIG. 2, fuel cell stack 10 is adapted to receive streams of a proton-liberating composition 42 and an oxidant 44 from sources 46 and 48. An example of a suitable proton-liberating composition is hydrogen gas, and a suitable oxidant is oxygen. Another illustrative example of a suitable proton-liberating composition is a solution of methanol and water. In the following discussion, the proton-liberating source will be referred to as hydrogen, and the oxidant will be referred to as oxygen, although any suitable compositions may be used. Hydrogen 42 and oxygen 44 may be delivered to the fuel cell stack via any suitable mechanism from sources 46 and 48. Examples of suitable sources 46 for hydrogen 42 include a pressurized tank, metal hydride bed or other suitable hydrogen storage device, a chemical hydride (such as a solution of sodium borohydride), and/or a fuel processor or other hydrogen generation assembly that produces a stream containing pure or at least substantially pure hydrogen gas from at least one feedstock. Illustrative (non-exclusive) examples of suitable feedstocks include one or more alcohol, polyalcohol, sugar, hydrocarbon, ammonia, organic acid), ether (such as dimethyl ether), and mixtures thereof. Examples of suitable sources 48 of oxygen 44 include a pressurized tank of oxygen, oxygen-enriched air, or air, or a fan, compressor, blower or other device for directing air to the cathode regions of the fuel cells in the stack.

The streams of hydrogen and oxygen are received by the fuel cell stack through input ports 43 and 45. The fuel cell stack includes any suitable structure for delivering portions of these streams to the respective anode and cathode regions of fuel cells 16. Fuel cell stack 10 also includes outlet ports 47 and 49 through which the anode and cathode exhaust streams from the cells are removed from the fuel cell stack. Although not required to all embodiments, the fuel cell stack may also include at least one inlet and outlet port 61 and 63 through which heat exchange fluid 65 is delivered and removed from the fuel cell stack to maintain the fuel cell stack at a predetermined operating temperature, or range of temperatures. The heat exchange fluid may be delivered via any suitable mechanism and may form either an open or closed heat exchange assembly. Illustrative, non-exclusive examples of suitable heat exchange fluids include air, water, and glycols, although others may be used. It is within the scope of the invention to use other mechanisms to heat and/or cool fuel cell stack 10, such as those shown in U.S. Pat. Nos. 4,583,583 and 5,879,826, the complete disclosures of which are herein incorporated by reference for all purposes. In the schematic examples shown in FIG. 2, the input and outlet ports are respectively illustrated on end plates 12 and 14. While this construction is not required, the relative thickness and stability of the end plates makes them suitable for the inclusion of these ports. It is within the scope of the present disclosure that the ports may be formed in any suitable location on the stack. For example, the ports may all extend through the same end plate, at least one inlet port and at least one outlet port may extend through the same end plate, at least one of the ports may extend through a portion of the fuel cell stack other than the end plates, etc.

The fuel cell stack may, but is not required to, also include a humidification region in which the air or other oxidant stream for the cathode regions is humidified, such as through exposure to a water-containing stream. An illustrative example of such a stream is cathode exhaust stream 55. This exchange may be accomplished by passing the. streams, within or exterior of the fuel cell stack, through a humidification assembly that includes a humidification membrane through which water may pass from the cathode exhaust (or other water-containing) stream to the air or other oxidant stream.

At least one energy-consuming device 51 may be electrically coupled to the fuel cell stack. Device 51 applies a load 22 to the stack and draws an electric current therefrom to satisfy the load. Illustrative examples of devices 51 include motor vehicles, recreational vehicles, boats and other seacraft, households, residences, offices, tools, lights and lighting assemblies, signaling and communications equipment, computers, batteries in need of recharging, and even the balance-of-plant electrical requirements for the fuel cell system of which stack 10 forms a part. The rated power output of the fuel cell stack will affect the applied load which the stack may be designed to satisfy. For example, stacks 10 according to the present disclosure may be designed to have a rated power output in the range of 100-1000 watts, such as for use as battery chargers, generators for backup power, wheel chairs, scooters, portable power systems, power systems for electrically powered components of recreational vehicles and seacraft, power sources for tools, appliances, and some computers and communication equipment. Illustrative, non-exclusive subsets of this range include rated power outputs of 100-400 watts, 100-300 watts, 200-500 watts, 300-600 watts, 200-750 watts, and 500-800 watts. As another example, stacks 10 may have a rated power output that is greater than 1 kW, such as a rated power output of approximately 1-1.5 kW for use supplying power to larger appliances, series of electronic devices, etc. As yet another example, a rated power output in the range of 3-6 kW, such as 4-5 kW may be suitable for supplying power to a household, apartment, office and the like. The fuel cell stack may further include, or be in communication with, a power management assembly 52 that includes any suitable structure to convert the electric current produced by the fuel cell stack to the appropriate power configuration for device 51, such as by adjusting the voltage of the stream (i.e., with a buck or boost converter), the type of current (alternating or direct), etc.

As discussed in more detail herein, fuel cell stack 10 also includes a compression system 100 that is adapted to apply compression to the fuel cell stack, with the compression urging the end plates toward each other, thereby compressing the fuel cells together to maintain effective seals and electrical contacts between the components of the stack, as well as the components of the individual cells. This compression may provide reduced electrical resistance and/or increased electrical conduction through the stack. This is schematically illustrated with arrows in FIGS. 1 and 2. As indicated, the compression is applied to urge the cells toward each other, thereby promoting seals and/or electrical contact between the corresponding portions of the cells and the stack. Unlike the conventional use of rigid tie rods that extend through the end plates to apply this compression, the compression systems 100 of the present disclosure are adapted to achieve the desired compression without requiring the use of these tie rods. The amount of compression to be applied may vary according to such factors as the construction of the fuel cells, including the type of gaskets used to form seals, the construction of the gas diffusion layers used in the cells, the desired operating conditions of the fuel cell stack, etc. For example, compression system 100 may be adapted to apply 50-300 pounds of force per square inch of cross-sectional area of the fuel cells (measured transverse to the direction at which the force is applied). Illustrative compression pressures include 50-200 pounds per square inch, 50-150 pounds per square inch, 75-150 pounds per square inch, 75-125 pounds per square inch, and 90-100 pounds per square inch. It is within the scope of the present disclosure that other compression pressures may be utilized, including pressures that are outside of the illustrative 50-300 pound rage introduced above, as well as other selected pressures within this range.

Fuel cell stacks 10 according to the present disclosure are compatible with a variety of different types of fuel cells, such as proton exchange membrane (PEM) fuel cells, as well as alkaline fuel cells, phosphoric acid fuel cells, direct methanol fuel cells, solid oxide fuel cells, and other fuel cells. For the purpose of illustration, an exemplary fuel cell 16 in the form of a PEM fuel cell is schematically illustrated in FIG. 3 and generally indicated at 24. Proton exchange membrane fuel cells and direct methanol fuel cells typically utilize a membrane-electrode assembly 26 that includes an ion exchange, or electrolytic, membrane 28 located between an anode region 30 and a cathode region 32. Each region 30 and 32 includes an electrode 34, namely an anode 36 and a cathode 38, respectively. Each region 30 and 32 also includes a supporting plate 40, such as at least a portion of a bipolar plate assembly that separates adjacent fuel cells and which may include flow fields associated with each plate.

In operation, hydrogen (gas) 42 is fed to the anode region, while oxygen (gas) 44 is fed to the cathode region. Stack 10 may include any suitable conduits, manifolds, collection assemblies, and the like to distribute and collect the various input and output streams from the plurality of fuel cells. Hydrogen and oxygen typically combine with one another via an oxidation-reduction reaction. Although membrane 28 restricts the passage of a hydrogen molecule, it will permit a hydrogen ion (proton) to pass therethrough, largely due to the ionic conductivity of the membrane. The free energy of the oxidation-reduction reaction drives the proton from the hydrogen gas through the ion exchange membrane. As membrane 28 also tends not to be electrically conductive, an external circuit 50 is the lowest energy path for the remaining electron, and is schematically illustrated in FIG. 3. In practice, a fuel cell stack contains a plurality of fuel cells with bipolar plate assemblies separating adjacent membrane-electrode assemblies. The bipolar plate assemblies essentially permit the free electron to pass from the anode region of a first cell to the cathode region of the adjacent cell via the bipolar plate assembly, thereby establishing an electrical potential through the stack that may be used to satisfy an applied load. This net flow of electrons produces an electric current that may be used to satisfy an applied load 22, such as from energy-consuming device 10 and/or the fuel cell system itself.

In cathode region 32, electrons from the external circuit and protons from the membrane combine with oxygen to produce water and heat. Also shown in FIG. 3 are an anode purge stream 54, which may contain hydrogen gas, and a cathode air exhaust stream 55, which is typically at least partially, if not substantially, depleted of oxygen. It should be understood that fuel cell stack 10 will typically have a common hydrogen (or other reactant) feed, air intake, and stack purge and exhaust streams, and accordingly will include suitable fluid conduits to deliver the associated streams to, and collect the streams from, the individual cells.

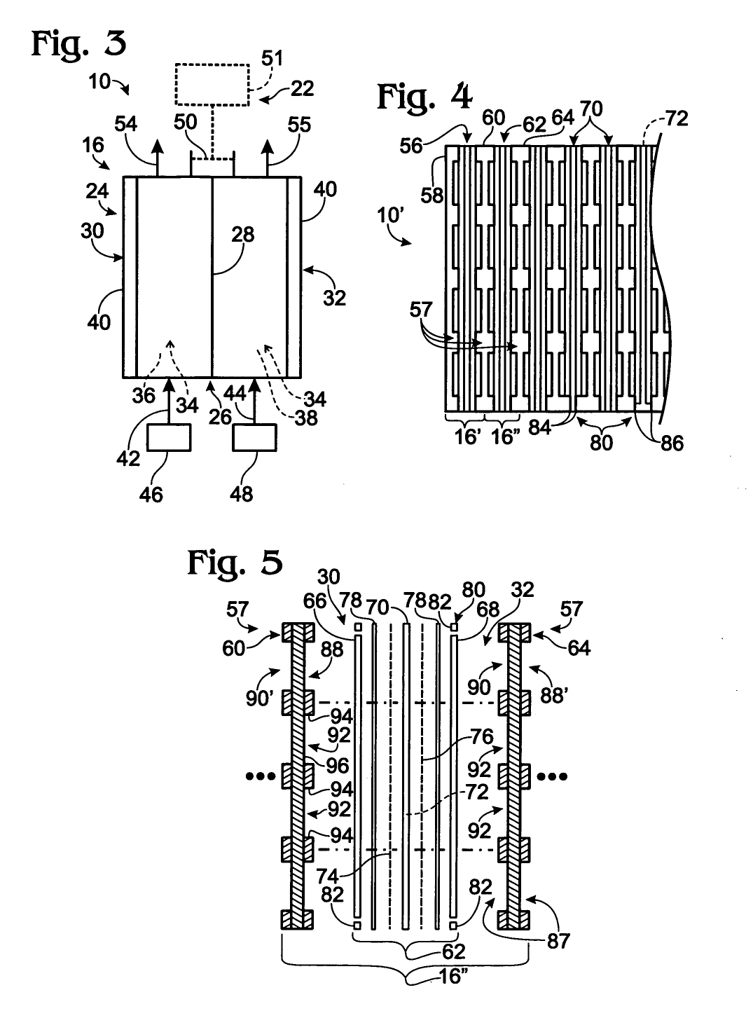

FIG. 4 shows a schematic representation of a fragmentary portion 10′ of fuel cell stack 10. As shown, portion 10′ includes a plurality of fuel cell assemblies, including fuel cell assemblies 16′ and 16″. Fuel cell assembly 16′ includes a membrane-electrode assembly (MEA) 56 positioned between a pair of bipolar plate assemblies 57, such as assemblies 58 and 60. Similarly, fuel cell assembly 16″ includes an MEA 62 positioned between a pair of bipolar plate assemblies 57, such as bipolar plate assemblies 60 and 64. Therefore, bipolar plate assembly 60 is operatively interposed between adjacently situated MEAs 56 and 62. Additional fuel cells may be serially connected in similar fashion, wherein a bipolar plate may be operatively interposed between adjacent MEAs. The phrase “working cell”is used herein to describe fuel cells, such as cells 16′ and 16″, that are configured to produce electric current and typically include an MEA positioned between bipolar plate assemblies. It is within the scope of the present disclosure that bipolar plate assemblies 57 may have any suitable construction, including constructions that include more than one layer, spaced-apart members, members that include heat exchange conduits, flow conduits, etc.

FIG. 5 shows an exploded schematic view of fuel cell assembly 16″, which as discussed includes a membrane-electrode assembly (MEA) 62 positioned between bipolar plate assemblies 60 and 64. MEA 62 includes an anode 66, a cathode 68, and an electron barrier 70 that is positioned therebetween. Electron barrier 70 may include any suitable structure and/or composition that enables protons to pass therethrough and yet retards the passage of electrons to bias the electrons to an external circuit. As an illustrative example, barrier 70 may include a membrane-supported electrolyte that is capable of blocking electrons, while allowing protons to pass. For example, in PEM fuel cells, electron barrier 70 may be a polymer membrane 72 configured to conduct hydrogen cations (protons) and inhibit electron flow, and as such may also be described as an ion exchange membrane. In an alkaline fuel cell, electron barrier 70 may be an aqueous alkaline solution or membrane. For phosphoric acid fuel cells, electron barrier 70 may be a phosphoric acid solution (neat or diluted) or membrane.

For at least PEM fuel cells, the electrodes, such as anode 66 and cathode 68, may be constructed of a porous, electrically conductive material such as carbon fiber paper, carbon fiber cloth, or other suitable materials. Catalysts 74 and 76 are schematically depicted as being disposed between the electrodes and the electron barrier. Such catalysts facilitate electrochemical activity and are typically embedded into barrier 70, such as into membrane 72. Cell 16″ will typically also include a gas diffusion layer 78 between the electrodes and catalysts 74 and 76. For example, layer 78 may be formed on the surface of the electrodes and/or the catalysts and may be formed from a suitable gas diffusing material, such as a thin film of powdered carbon. Layer 78 is typically treated to be hydrophobic to resist the coating of the gas diffusion layers by water present in the anode and cathode regions, which may prevent gas from flowing therethrough. It should be understood that it is desirable to have a fluid seal between adjacent bipolar plate assemblies. As such, a variety of sealing materials or sealing mechanisms 80 may be used at or near the perimeters of the bipolar plate assemblies. An example of a suitable sealing mechanism 80 is a gasket 82 that extends between the outer perimeters of the bipolar plate assemblies and barrier 70. Other illustrative examples of suitable sealing mechanisms 80 are schematically illustrated in the lower portion of FIG. 4 and include bipolar plate assemblies with projecting flanges 84, which extend into contact with barrier 70, and/or a barrier 70 with projecting flanges 86 that extend into contact with the bipolar plate assemblies. In some embodiments, it may be desirable for the cells to include a compressible region between adjacent bipolar plate assemblies, with gaskets 82 and membranes 72 being examples of suitable compressible regions that permit the cells, and thus the stack, to be more tolerant and able to withstand external forces applied thereto.

As shown in FIG. 5, bipolar plate assemblies 60 and 64 extend along opposite sides of MEA 62 so as to provide structural support to the MEA. Such an arrangement also allows the bipolar plate assemblies to provide a current path between adjacently situated MEAs. Bipolar plate assemblies 60 and 64 are shown with flow fields 87, namely anode flow fields 88 and cathode flow fields 90. Flow field 88 is configured to transport fuel, such as hydrogen, to the anode. Similarly, flow field 90 is configured to transport oxidant, such as oxygen, to the cathode and to remove water and heat therefrom. The flow fields also provide conduits through which the exhaust or purge streams may be withdrawn from the fuel cell assemblies. The flow fields typically include one or more channels 92 that are at least partially defined by opposing sidewalls 94 and a bottom, or lower surface, 96. It should be understood that flow fields 88 and 90 have been schematically illustrated in FIG. 5 and may have a variety of shapes and configurations. Similarly, the channels 92 in a given flow field may be continuous, discontinuous, or may contain a mix of continuous and discontinuous channels. Examples of a variety of flow field configurations are shown in U.S. Pat. Nos. 4,214,969, 5,300,370, and 5,879,826, the complete disclosures of which are hereby incorporated by reference for all purposes. Additional illustrative examples of suitable constructions for fuel cell stacks are disclosed in U.S. Pat. Nos. 5,879,826 and 6,403,249, the complete disclosures of which are hereby incorporated by reference for all purposes.

In the schematic example shown in FIG. 5, cathode region 32 may be referred to as a closed cathode region because gasket 82 extends around the cathode region to prevent external air from diffusing or otherwise being drawn into the cathode region except when delivered through internal conduits from the air/oxidant source. In a variation of this construction, the cathode regions of fuel cell stack 10 include passages, such as at a perimeter edge of the cathode regions. For example, the bipolar plate assemblies may include one or more voids or apertures that define flow passages through which air from external the fuel cell stack may flow into the cathode regions without requiring an air delivery system to deliver an air stream to the fuel cell stack and thereafter be divided within internal conduits for delivery to the individual fuel cells. Instead, either no fan, blower or other air delivery system may be used, or a far or other external blower may be used simply to urge external air toward and into the passages. In this construction, the cathode region may be referred to as an open cathode region.

As also shown in FIG. 5, the bipolar plate assemblies may include both anode and cathode flow fields, with the flow fields being generally opposed to each other on opposite faces of the bipolar plate assemblies. This construction enables a single bipolar plate assembly 57 to provide structural support and contain the flow fields for a pair of adjacent MEAs. For example, as illustrated in FIG. 5, bipolar plate assembly 60 includes anode flow field 88 and a cathode flow field 90′, and bipolar plate assembly 64 includes cathode flow field 90 and an anode flow field 88′. Although many, if not most or even all of the bipolar plate assemblies within a stack will have the same or a similar construction and application, it is within the scope of the disclosure that not every bipolar plate assembly within stack 10 contains the same structure, supports a pair of MEAs or contains oppositely facing flow fields.

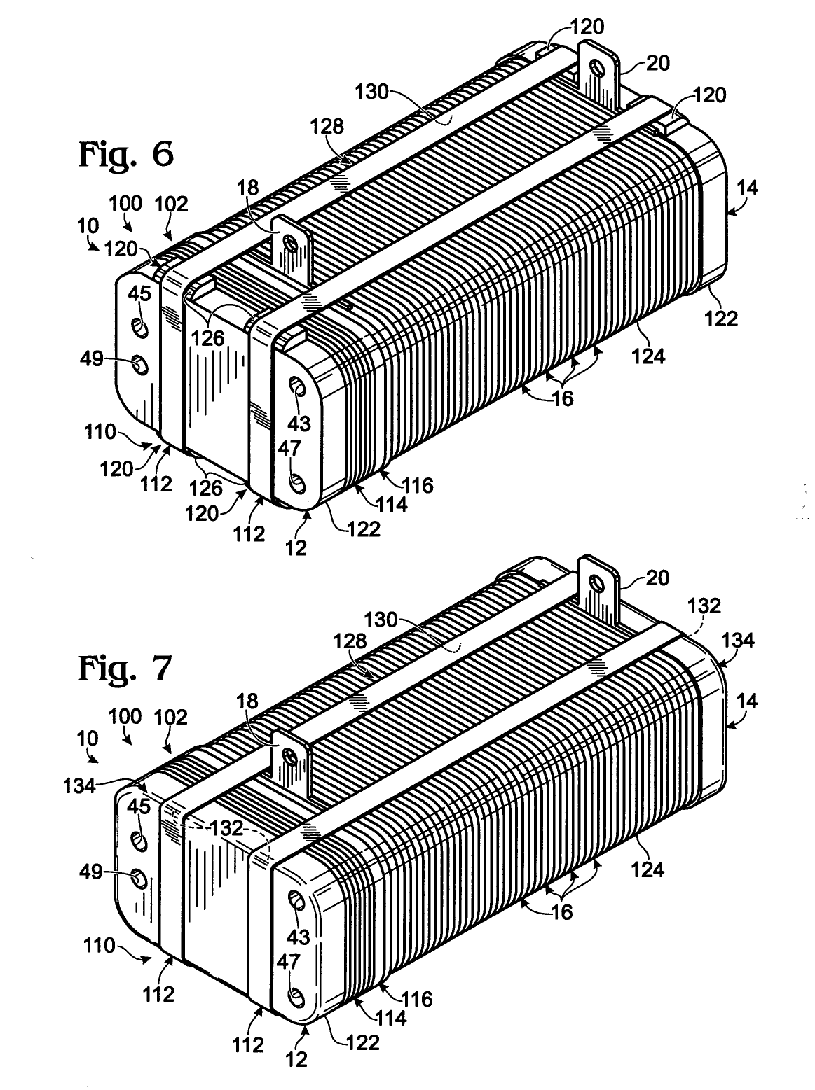

In FIG. 6, an example of a fuel cell stack 10 with a stack compression system 100 according to the present disclosure is shown. As shown, system 100 includes a strap assembly 110 that includes at least one compressive band 112 that extends around the end plates of the fuel cell stacks to compress the end plates toward each other and thereby provide the previously described compression to the fuel cells in the stack. Band 112 may be described as forming a closed loop that extends around the end plates and fuel cells of the stack. As such, compression system 100 may be referred to as a banded compression system 102. Bands 112 may be formed from any suitable material that may apply the desired compression to the stack. Illustrative materials include metal, such as stainless or other steel, and plastic or polymeric materials. The bands may have a defined perimeter or may be at least slightly elastically deformable. With respect to a comparable (i.e., same number and size of fuel cells, same material of construction for end plates, etc.) fuel cell stack that utilizes conventional end plates with a compression system that utilizes conventional tie rods, stack 10 and banded compression system 102 should enable (but not require) the end plates to be thinner and the stack to be lighter. The reduction in thickness of the plates and the removal of tie rods may also reduce the volume of the stack, although this too is not required.

In the illustrated example shown in FIG. 6, a pair of spaced-apart bands 112 are shown extending generally parallel to each other. It is within the scope of the present disclosure that strap assembly 110 may utilize a single band or more than two bands. When two or more bands are used, it is also within the scope of the present disclosure that the bands may extend in orientations other than parallel, side-by-side orientations relative to each other. For example, the bands may extend at intersecting or divergent angles relative to each other, may extend at right angles to each other, etc. The number of bands to be used may be affected by the desired degree of compression to be applied by each band, the desired degree of compression to be applied by the compression system collectively, the material(s) from which the band is formed, and the size (i.e., thickness, width, etc.) of the band. For example, if it desirable to apply at least 600 pounds of force to the end plates, then strap assembly 110 may include a pair of bands that each apply at least 300 pounds of force, three bands that each apply at least 200 pounds of force, a single band that applies at least 600 pounds of force, etc. While not required, it may be desirable to use more than one strap to increase the distribution of the applied compressive force across the end plates, such as to resist deformation of the end plates that could lead to leaks or reduced electrical contact.

The fuel cell stack 10 shown in FIG. 6 also provides an example of a fuel cell stack in which the input ports 43 and 45 for hydrogen and air, and the outlet ports 47 and 49 for the anode and cathode exhaust streams, extend through the same end plate. The illustrated fuel cell stack also provides a graphical example of a fuel cell stack that includes a humidification region 114 within the stack. At 116, a transition region between the humidification region and the fuel cells is shown. As discussed, the humidification region may be located external the stack or may not be used at all. Similarly, banded compression system 102 may be used with any of the fuel cell stacks described or illustrated herein.

In FIG. 6, the compression system includes lateral projecting members 120 that extend from the outer perimeter sidewalls 122 of the end plates to position the band in a spaced-apart relationship to the outer perimeter edges 124 of fuel cells 16. In the illustrated example, members 120 include an arcuate transition region 126 so that the band is not creased or otherwise folded to form an edge around the projecting members. Projecting members 120 may also be described as being offsets or lateral extensions that extend from the end plates. The projecting members may be integrally formed with the end plates or separately formed and thereafter permanently or removably attached or coupled to the end plates. The lateral spacing of the bands may be desirable when the bands are formed from a metallic or other conductive material, in which case it is desirable to prevent the bands from contacting conductive portions of the fuel cells. This lateral spacing may also provide clearance (i.e. an open region) 128 under the band, such as to provide a region in which portions of a clamp, crimping tool, or other tensioning and/or fastening tool may extend to secure the band around the stack. This open region 128 may be described as being an externally accessible passage between the outer perimeter edges of the fuel cells and the underside (i.e., cell-facing surface) 130 of the band. If the end plates are sufficiently oversized relative to the fuel cells, i.e., have cross-sectional areas that are sufficiently larger than the corresponding cross-sectional areas of the fuel cells to provide the desired amount of clearance, then the open region may be provided without members 120. However, this construction will increase the materials and weight of the end plates.

FIG. 7 provides an example of the banded compression system 102 of FIG. 6 used with a fuel cell stack 10 that does not include projecting members 120. As discussed, this construction may be utilized when it is not desired to have an open region 128 between the band(s) and the outer perimeter edges of the fuel cells, when it is permissible for the band(s) to contact the outer perimeter edges of the fuel cells and/or when the end plates provide sufficient clearance between the band(s) and the outer perimeter edges of the cells. Even without the inclusion of lateral projecting members, it may still be desirable to include an arcuate transition region 132 along at least the edge regions 134 of the end plates that are contacted by the strap assembly. This transition region may extend continuously around the edge regions or in discontinuous lengths.

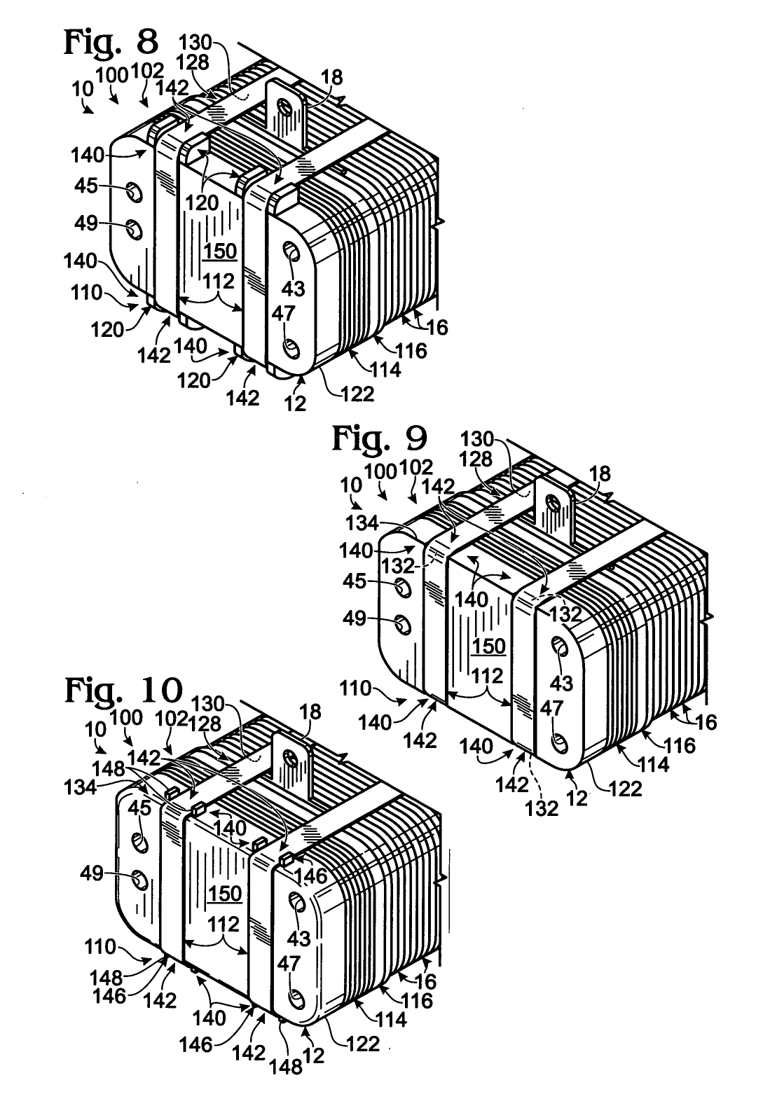

FIGS. 8 and 9 demonstrate variations of the banded compression systems shown in FIGS. 6 and 7. More specifically, FIGS. 8 and 9 illustrate banded compression systems 102 in which the end plates include positioning structure 140, such as channels 142, that are sized to receive the bands of the strap assembly to position the bands in predefined positions relative to each other and the end plates. Channels 142 have a width that is approximately the same size as, and optionally up to 10% or perhaps 20% larger than, the width of the bands 112 of the strap assembly. This positioning structure enables the compressive forces applied by the compression system to be precisely located relative to the end plates and thereby not subject to the particular positioning decided upon by a user applying bands to end plates without structure 140. The positioning structure and/or the end plates may also be described as including removed regions that are sized to receive the bands. A further example of a suitable positioning structure 140 is shown in FIG. 10, in which the end plates include spaced-apart guides 146, such as ribs 148, that project from the end plates to define channels 142. In the illustrated example, the guides project from the sidewall 122 of end plate 12, but it is within the scope of the present disclosure that the guides additionally or alternatively may project from the end wall 150 of the end plate.

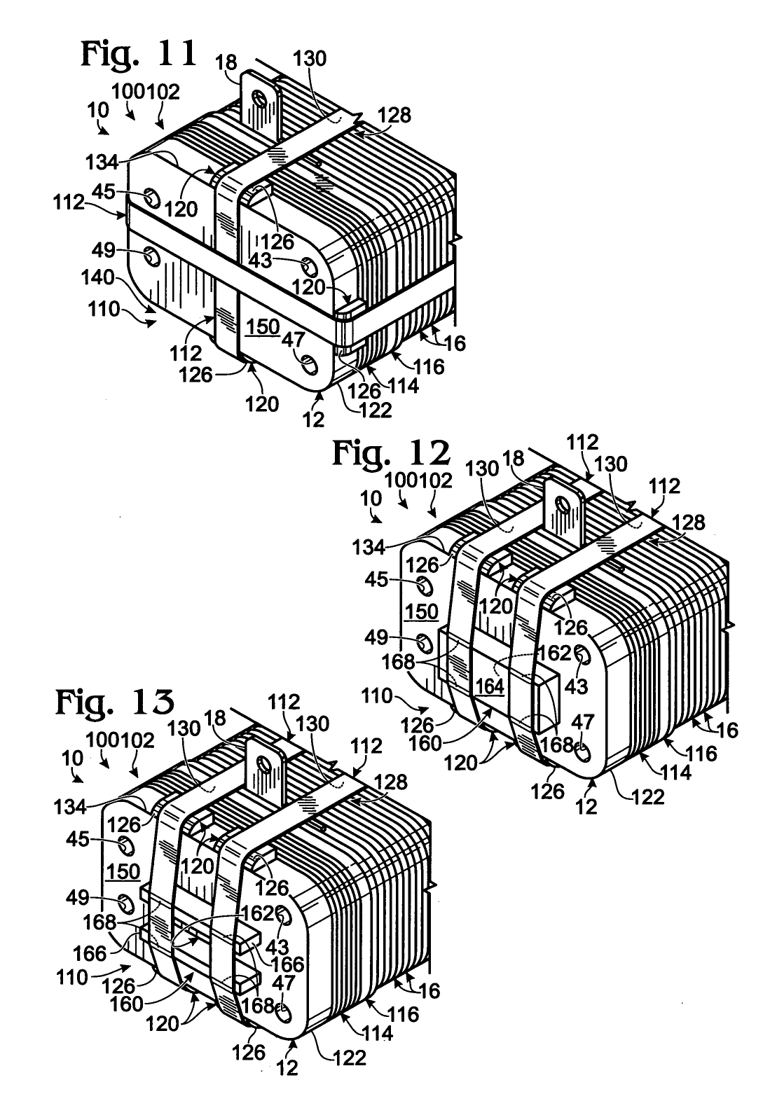

As discussed, strap assembly 110 may include only a single band, a pair of bands, or more than two bands, intersecting bands, etc. FIG. 11 provides a graphical example of an example of a fuel cell stack 10 with a banded compression system 102 that includes a strap assembly 110 with intersecting bands 112. A consideration when determining the number of bands to be used for a particular strap is not only the total compressive force that is desired, but also how the compressive force is transmitted to the fuel cells, such as to the central, or active, regions of the fuel cells and/or to the perimeter regions of the fuel cells. A related consideration is whether the compressive forces will cause distortion in the end plates. Therefore, the intersecting bands of FIG. 11 may provide increased compression at the central regions of the end plates and fuel cells, but may provide less compression at the corner regions of the plates and cells. However, the construction of the bands, thickness and construction of the end plates, user preferences, etc. are all factors that affect this analysis. It is within the scope of the present disclosure that at least one transverse, intersecting band may also be used with any of the illustrative examples of FIGS. 6-10.

Compression systems 100, such as banded compression systems 102, according to the present disclosure may further include projecting structure 160 that extends from the central portions 162 of the end plates' end walls 150. Structure 160 is sized and positioned so that the strap assembly applies at least as much, or more, compressive force to structure 160 than to the edge regions of the end plates. This force is thereby distributed to the central regions of the fuel cells and provides a counter against compressive forces that are applied primarily at the edges of the end plates and which may cause distortion in the central regions of the end plates and/or comparatively less transmission of the compressive forces to the central regions of the fuel cells. Structure 160 may be described as force-locating structure, or force-directing structure, in that the positioning of structure 160 on the end plates affects the distribution of the compressive forces to the end plates and the fuel cells. Structure 160 may be integrally formed with the end plates, may be separately formed and thereafter secured to the end plates, or may be coupled to the end plates simply by the compressive forces applied by the stack compression system. Illustrative examples of force-directing structure 160 are shown in FIGS. 12 and 13. In FIG. 12, end plate 12 is shown including a central block 164 that extends from central portion 162 of end wall 150 generally away from the fuel cells. In FIG. 13, a pair of spaced-apart ribs 166 are shown extending from central portion 162 of end wall 150 generally away from the fuel cells. The number, placement, and orientation of ribs 166 may vary without departing from the scope of the disclosure. Block 164 and ribs 166 include bearing surfaces 168 that are designed to be engaged by the strap assembly to receive the compressive forces imparted thereby. It is within the scope of the present disclosure that structure 160 may be used with any of the stack compression systems described and/or illustrated herein.

As discussed, bands 112 form a loop, and preferably a closed loop, that extends around the end plates and cells of fuel cell stack 10. The bands themselves may be. integrally formed as a closed loop of a predetermined size. When the bands are constructed from a material that is elastically deformable, the size of the bands may increase somewhat when stretched, but the bands will be biased to return to the selected original size. As another example, the bands may be formed from lengths having end regions that are permanently or releasably secured together to define a closed loop having a predetermined size. By “permanently secured together,” it is meant that the end regions are welded, diffusion bonded, brazed or otherwise secured together such that they cannot be separated without destroying at least a portion of the band or the fastening mechanism utilized to permanently secure the end regions together. By “releasably secured together,” it is meant that the end regions are adapted to be repeatedly coupled together and uncoupled, or otherwise released from engagement, without destroying a portion of the band or a fastening mechanism utilized to releasably couple the end regions together.

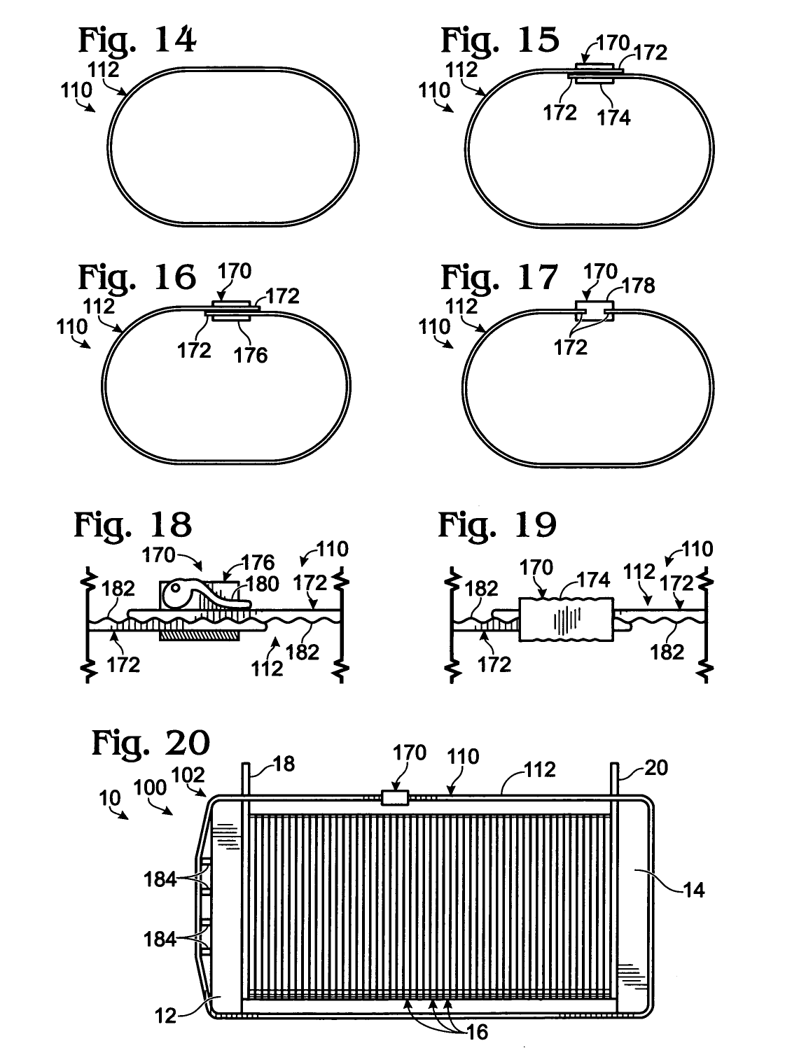

As indicated above, strap assembly 110 may, but is not required to, include at least one fastening mechanism in addition to at least one band 112. Illustrative examples of permanent fastening mechanisms include welds, adhesive bonds, diffusion bonds, rivets and other fasteners that pass through the end regions of the bands, one-time-use clamps and clips that, once clamped upon or otherwise fastened to the end regions, are not adapted to be removed without destroying at least a portion of the fastener or band, etc. Illustrative examples of releasable fastening mechanisms include clips, buckles, latches, and other mechanisms that are adapted to releasably secure the end regions together to establish a defined perimeter size for the band, but which may be released, such as to remove the band or resize the band, and thereafter be resecured to select the same or a different perimeter size for the band. It is within the scope of the disclosure that the end regions of a band may be directly secured together or that they may be secured together by a linkage or other intermediary structure that interconnects the end regions to secure the band in a selected perimeter size. In FIGS. 14-17, illustrative examples of strap assemblies 110 are shown to provide graphical, albeit somewhat schematic, illustrations of suitable strap assemblies, with FIGS. 15-17 providing examples of strap assemblies that include at least one fastening mechanism 170. For example, in FIG. 14 a strap assembly 110 is shown that includes a band 112 that forms a continuous loop without requiring a fastening mechanism to join the end regions of the band together. In FIG. 15, strap assembly 110 is shown including a band 112 with end regions 172 that are permanently secured together by a fastening mechanism 170 in the form of a permanent fastening mechanism 174. In FIG. 16, strap assembly 110 is shown including a band 112 with end regions 172 that are releasably secured together by a fastening mechanism 170 in the form of a releasable, reusable fastening mechanism 176. In FIG. 16, the end regions are secured together in an overlapping relationship by the fastening mechanism, while in FIG. 17, the end regions are linked by the fastening mechanism, which forms a linkage 178 that interconnects the end regions to form a portion of the closed loop.

In addition to optionally utilizing fastening mechanisms to secure the end regions of the bands together, it is also within the scope of the present disclosure that bands which do not themselves form closed loops include retention structure that is adapted to secure, or at least retain, the end regions of the bands at a selected perimeter size. For example, at least the end regions of the bands may include friction-enhancing surfaces, grooved surfaces that are adapted to interlock with corresponding surfaces on the other end region, etc. An illustrative example of such a construction is shown in FIG. 18, in which end regions 172 include retention structure 180 in the form of spaced-apart grooves, or teeth, 182, with the retention structure of the end regions being adapted to interlock or inter-engage with each other when the end regions are overlapping and pressed together. In the illustrative example shown in FIG. 18, a releasable fastening mechanism 176 that includes a releasable latch member 180 is shown. In FIG. 19, a similar band is shown, with end regions 172 secured together by a fastening mechanism 170 in the form of a permanent fastening mechanism 174.

When securing the strap assembly around the fuel cell stack, any suitable method may be used. For example, the fuel cell stack may be assembled and then compressed in a vise, clamp, press or other structure that is sized to compress the stack prior to application of the banded compression system. The strap assembly may thereafter be secured to the stack, and then the assembled stack and compression system may be removed from the vise or other structure. When the bands of the strap assembly form a closed loop that is sufficiently elastically deformable and/or where the vise or other tool reduces the length of the stack slightly beyond the desired assembled length, the loop may be slipped around the stack. When the bands of the assembly include end regions that are secured together by a fastening mechanism, the fastening mechanism may be applied to the end regions, optionally with the use of a tensioning or other fastening tool, while the stack is in the vise or other compressive tool.

In some embodiments, the strap assembly may include a fastening mechanism that includes a worm gear, cam, releasable linkage, or other adjustable tensioning mechanism that is adapted to draw the end regions of the strap assembly toward each other in a direction to reduce the size of the perimeter defined by the corresponding band. In such an embodiment, the band(s) of the strap assembly may be positioned around the fuel cell stack, and thereafter the tensioning mechanism is adjusted to apply the desired amount of tension to the band, thereby imparting compressive forces to the fuel cell stack. In a further variation, the banded compression system may include cams, wedges or other inserts 184 that are inserted between the fuel cell stack, such as one or both of the end plates, and the strap assembly to increase the tension in the band(s) of the strap assembly and thereby increase the compressive forces applied to the stack. Such a banded compression system is schematically illustrated in FIG. 20. Inserts 184 may be used with any of the compression systems 100 described and/or illustrated herein. Inserts 184 are separately formed from the rest of the stack and typically will not be secured, other than by compressive forces applied by strap assembly 110, to the end plates or other portion of the stack. In some embodiments, the inserts may be adapted to be configurable within a range of sizes, such as by manipulating gears, cams, or other mechanisms forming part of the inserts. In still other embodiments, the inserts may be monolithic or otherwise fixed-shape structures.

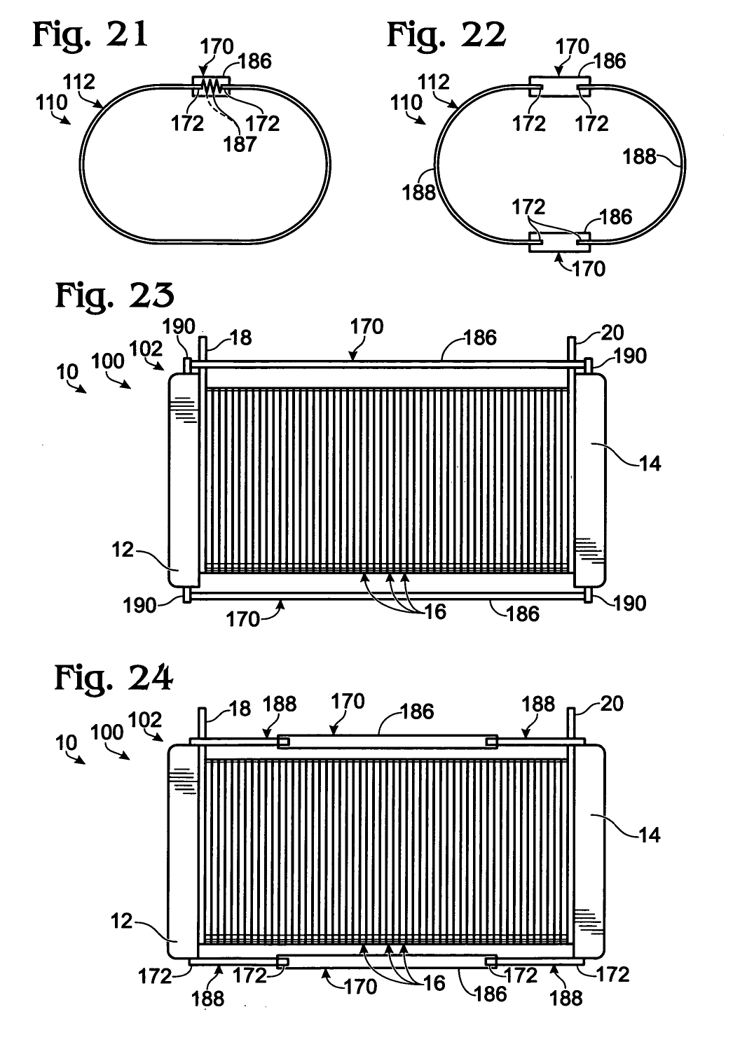

FIG. 21 illustrates another example of a suitable fastening mechanism 170 for strap assembly 110, namely, a fastening mechanism in the form of a biasing member 186 that is adapted to interconnect end regions 172 of the band and to urge the end regions together or otherwise in a direction to apply compression to the stack with the band. An illustrative example of a biasing member is a spring, such as a tension spring, which is graphically illustrated in FIG. 21 at 187. Other illustrative examples include elastomeric, or elastically, deformable members that interconnect end regions or other portions of the band and draw these portions together to apply compression, such as any of the illustrative compression values or ranges described herein, to the stack. A potential benefit of a fastening mechanism in the form of a biasing member is that the biasing mechanism will permit slight elongation and/or contraction of the perimeter defined by the band as the stack expands and contracts, such as responsive to the temperature of the stack. Preferably, the biasing member and corresponding strap assembly are designed to provide at least a selected, sufficient amount of compression to the stack at the range of operating conditions experienced during use of the stack.

While not required, when stack 10 includes a stack compression system with a strap assembly that includes a fastening mechanism in the form of a biasing member, the strap assembly may be applied by enlarging the perimeter of the band by urging the biasing member against its bias (i.e., elongating or otherwise stretching the spring or elastomeric member) so that the band may be positioned around the stack. The stack may optionally be compressed in a vice, clamp, or similar structure, such as described above, prior to the strap assembly being attached thereto. Thereafter, the biasing member may be released from these elongating forces so that the member applies the desired compression to the stack.

While described above as being a fastening mechanism in the form of a biasing member, it is within the scope of the present disclosure that the biasing member may form only a portion of the fastening mechanism, such as with the fastening mechanism also including a permanent or releasable fastening mechanism. It is further within the scope of the present disclosure that the strap assembly includes at least one biasing member and at least one separate fastening mechanism. As a further example, it is within the scope of the present disclosure that strap assembly 110 may include two or more fastening mechanisms, with these fastening mechanisms having the same or different constructions. For example, the strap assembly may include at least one band with a releasable fastening mechanism and a permanent fastening mechanism, at least one band with a releasable fastening mechanism and a biasing member, at least one permanent fastening mechanism and a biasing member, etc. In FIG. 22, an example of a strap assembly 110 is shown that includes a band 112 formed from two segments 188 that are connected by a pair of fastening mechanisms 170. In the illustrated example, each band segment 188 includes end regions 172, with one end region from each band segment being interconnected by each of the fastening mechanisms. In FIG. 22, the fastening mechanisms are illustrated as being and/or including a biasing member 186, but any of the other fastening mechanisms described, illustrated and/or incorporated herein may be used without departing from the scope of the present disclosure. The band 112 shown in FIG. 22 may be described as including spaced-apart band segments that are interconnected by fastening mechanisms to form a closed loop that extends around the fuel cell stack to apply compression thereto.

FIG. 23 illustrates an example of a stack compression system 100 that includes at least one biasing member 186 that extends directly between the end plates of the stack to apply the desired compression (such as described herein) thereto. In other words, FIG. 23 illustrates a stack compression system in which the end plates of the stack are urged toward each other to apply suitable compression to the fuel cells, with this compression being applied by biasing members that interconnect the end plates to draw the end plates toward each other. For example, the end plates may include receivers or other mounts or points of connection 190 for the biasing members. In FIGS. 22-24, the biasing members have been schematically illustrated and may include any suitable structure meeting the criteria set forth herein for the biasing members. As discussed, suitable examples of biasing members include tension springs and elastomeric members. In the illustrative example, two biasing members are indicated in solid lines, but it is within the scope of the present disclosure that any suitable number of biasing members may be used, including more than two such members. For example, in some embodiments, it may be desirable to have at least one biasing member extending between each of the edges of the end plates, in some embodiments, it may be desirable to have at least two biasing members extending between at least two of the edges of the end plates, etc. In FIG. 24, the stack compression system includes band segments 188 that extend from the end plates and which are interconnected by biasing members 186, which may (but are not required to) form at least a portion of fastening mechanisms 170 to interconnect the band segments. The band segments may be integrally formed with the end plates or secured to the end plates. For example, the band segments may include an end region 172 that is welded or otherwise fastened or coupled to one of the end plates and another end region 172 that is adapted to be interconnected with an end region of another band segment by a biasing member or other fastening mechanism.

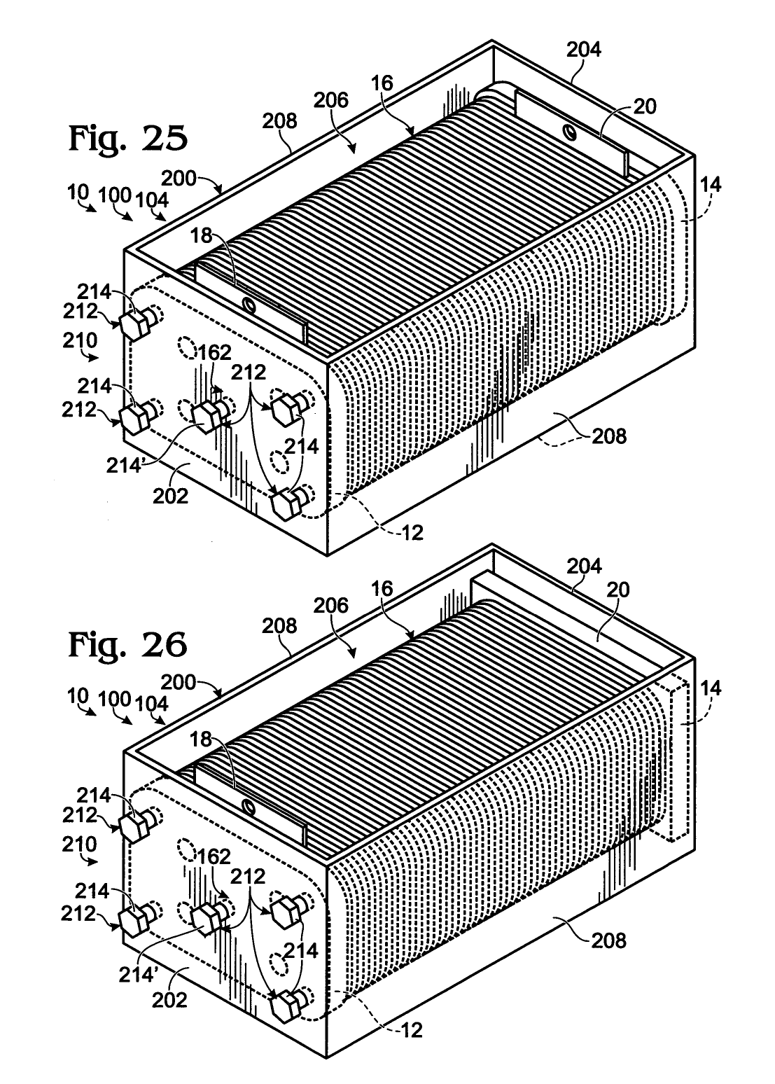

Another example of a fuel cell stack 10 with a stack compression system 100 according to the present disclosure is shown in FIG. 25. Similar to the banded and other stack compression systems described herein, the illustrated compression system is also free from conventional tie rods and thus may be referred to as a compression system that does not require conventional tie rods to extend between and through the end plates to provide the required compression to the fuel cells in the stack. In the illustrative example, compression system 100 includes an external frame 200 that surrounds fuel cells 16 and end plates 12 and 14 on at least four sides. More specifically, the frame includes a pair of spaced apart end walls 202 and 204 that define a compartment 206 extending therebetween, with the compartment being sized to receive the fuel cell stack's end plates, fuel cells, electrical contacts or buses 18 and 20, etc. in an operative orientation. It is within the scope of the present disclosure that any of the fuel cell stack configurations described and illustrated herein may be used. As illustrated, the stack does not include an internal humidification region, but such a region may be used. Similarly, the size and/or number of cells may vary.

Frame 200 further includes at least one, and typically at least two or at least three sidewalls 208 extending between the end walls. The compression system also includes a compression mechanism 210, which in the illustrated example takes the form of jacking members 212 that extend from one of the frame's end walls, in this case end wall 202, to urge end plate 12, and thus the fuel cells, toward the other end wall, namely, end wall 204. The illustrated frame-based compression system may be referred to as a framed (stack) compression system, a jacking (stack) compression system, or a jacking-box (stack) compression system, and it is indicated generally at 104 in FIGS. 25-29.

In the illustrative example shown in FIG. 25, the jacking members take the form of a plurality of screws 214 that extend through end wall 202 to engage end plate 12. As the screws are turned in a direction to drive the screws toward end plate 12, the screws engage the end plate and apply compression that is transmitted to the fuel cells. The number and position of jacking screws may vary without departing from the scope of the present disclosure. Similarly, other extendable members that are selectively urged into the frame's compartment to compress the fuel cells may be used. A benefit of having a plurality of jacking screws or other members that individually engage and apply compression to the end plate is that the amount of compression provided by a particular screw may be adjusted without requiring adjustment to the compression provided by others of the jacking screws. As an illustrative example, one of the jacking screws, which is indicated at 214′ is positioned to engage and apply compression to central region 162 of the end plate's end wall. Others of the jacking screws are positioned to engage and apply compression to a perimeter region of the end plate. The relative level of compression provided at the central region of the end plate may therefore be adjusted to be different, such as less, or more, than the compression applied at the peripheral region.

The framed compression system 104 shown in FIG. 25 applies the necessary compressive forces to the fuel cells, such as any of the illustrative compressive forces described above, without requiring the use of tie rods or other structure that extends through the end plates and/or the fuel cells. Instead, the compressive forces are provided by placing the fuel cell stack within a frame and applying compression to the stack within this frame. Frame 200 may be formed from any suitable material(s) having sufficient strength to withstand the applied forces and which is/are suitable for use in the operating environment within which the fuel cell stack will be used. Illustrative materials include metals, such as various stainless and other steels. Other illustrative examples include composite materials, heavily crosslinked plastics, ABS, fiberglass composites, and bakelite. The application of the compressive forces via the frame and compression mechanism 210 may reduce the weight of the fuel cell system by not requiring rigid tie rods and end plates that are sufficiently thick to resist deformation when the tie rods are used to apply compression to the fuel cells. In fact, because frame 200 itself may provide structural support to the components of the fuel cell stack, the thickness of at least one, if not both, of the end plates may be reduced.

As a further variation, it is within the scope of the present disclosure that at least a portion of the fuel cell stack's end plates are incorporated into either the frame or the compression mechanism. For example, in FIG. 26, another fuel cell stack 10 with a framed compression system 104 is shown. Stack 10 and compression system 104 are similar to the structure described and illustrated with respect to FIG. 25 except that end plate 14 has been removed and end wall 204 of the frame instead provides the structural support to the fuel cells and bus 20. Described in other terms, a portion of the frame, namely end wall 204, forms an end plate of the fuel cell stack. In the illustrative example, another suitable construction for conductive bus 20 is also shown. FIG. 26 also provides a graphical illustration of a frame 200 that includes only a pair of sidewalls 208, although additional sidewalls may be used.

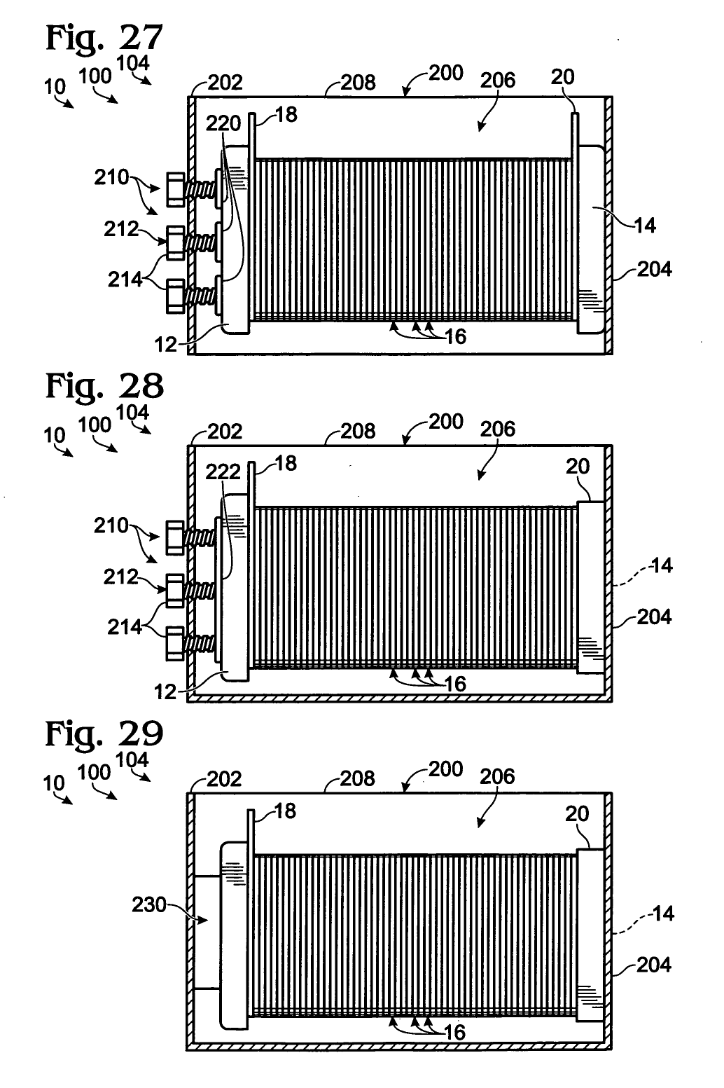

In FIGS. 25 and 26, jacking members 212 take the form of screws that extend through end wall 202 of the frame to engage an end plate of the fuel cell stack to apply the requisite, as discussed previously, compression to the fuel cells of the stack. As discussed, the utilization of a plurality of jacking, or compression, members that each may be adjusted independent of the rest of the jacking members may offer the benefit of being able to apply different levels of compression, or the same level of compression, across the end plate through the selective adjustment of the screws or other jacking members. In some embodiments, it may still be desirable to distribute the compressive force that is applied to the end plate and fuel cells of the fuel cell stack more broadly than is provided for simply by the tips of the screws. In FIG. 27, the jacking members include engagement heads 220 that are wider than the tips of the screws and are designed to distribute the compressive forces applied by the screws across a larger region of contact than when the engagement heads are not present. In FIG. 28, the framed compression system includes a compression plate, or jacking plate, 222 that extends within compartment 206 and which extends between the jacking members and the end plate (12) of the fuel cell stack that is proximate the jacking members. Compression plate 222 is adapted to be engaged by screws 214 or other jacking members 212 of compression mechanisms 210 and to transmit the compressive forces applied thereto to end plate 12. Compression plate 222 is typically not secured to the end plate other than through the compressive forces themselves. Plate 222 may be similarly not secured to the screws or other jacking members other than through the compressive forces as the screws engage the plate and urge it against end plate 12, or the compression plate may be interconnected with the screws or other jacking members via any suitable connective structure.

In FIG. 29, another fuel cell stack with a stack compression system 100 in the form of a framed compression system 104 is shown. As shown, an adjustable compression mechanism 230 extends between end wall 202 of frame 200 and end plate 12 of the fuel cell stack. As illustrated, the mechanism 230 extends directly in connection with wall 202 and end plate 12, and the fuel cell stack includes the integrated end wall/end plate construction discussed above with respect to FIG. 26. It is within the scope of the present disclosure that frame 200 and the other elements of stack 10 may have any of the configurations and/or structure disclosed and/or illustrated herein. Similarly, compression system 104 may include a compression plate or other intermediate structure in between one or more of end walls 202, compression mechanism 230, and end plate 12. As a further variation, the compression plate and end plate 12 may be unified into a composite structure in any embodiments of compression mechanism 230 where a compression plate is used.

Compression mechanism 230 may include any suitable structure for urging the end plate and end wall away from each other, to apply the previously described compressive forces to the fuel cells 16 within the stack. Compression mechanism 230 may be adapted to provide the desired compressive forces automatically upon insertion and proper positioning of the compression mechanism between end wall 202 and end plate 12. An example of such a compression mechanism is one or more wedges and/or cams that are inserted into the compartment between wall 202 and end plate 12. Another example includes one or more, including two, three, five, or more springs that are inserted directly or indirectly between wall 202 and end plate 12 and are oriented to provide the desired compressive forces. It is also within the scope of the present disclosure that the compressive force applied by compression mechanism 230 is adjustable, such as within a range of suitable compressive forces that all meet the criteria described herein and/or within a range of compressive forces of which some meet the criteria described herein and others do not. For example, a compression mechanism in the form of one or more adjustable cams may enable a user to adjust the applied compressive forces by rotating the cam. Similarly, the previously described wedge may also be described as an adjustable compression mechanism to the extent that the wedge may be repositioned, such as by further insertion or partial removal of the wedge to adjust the compressive forces applied thereby. A further example is one or more lever-actuated members that are pivotal within a range of positions to control the magnitude of the compressive forces applied thereby.

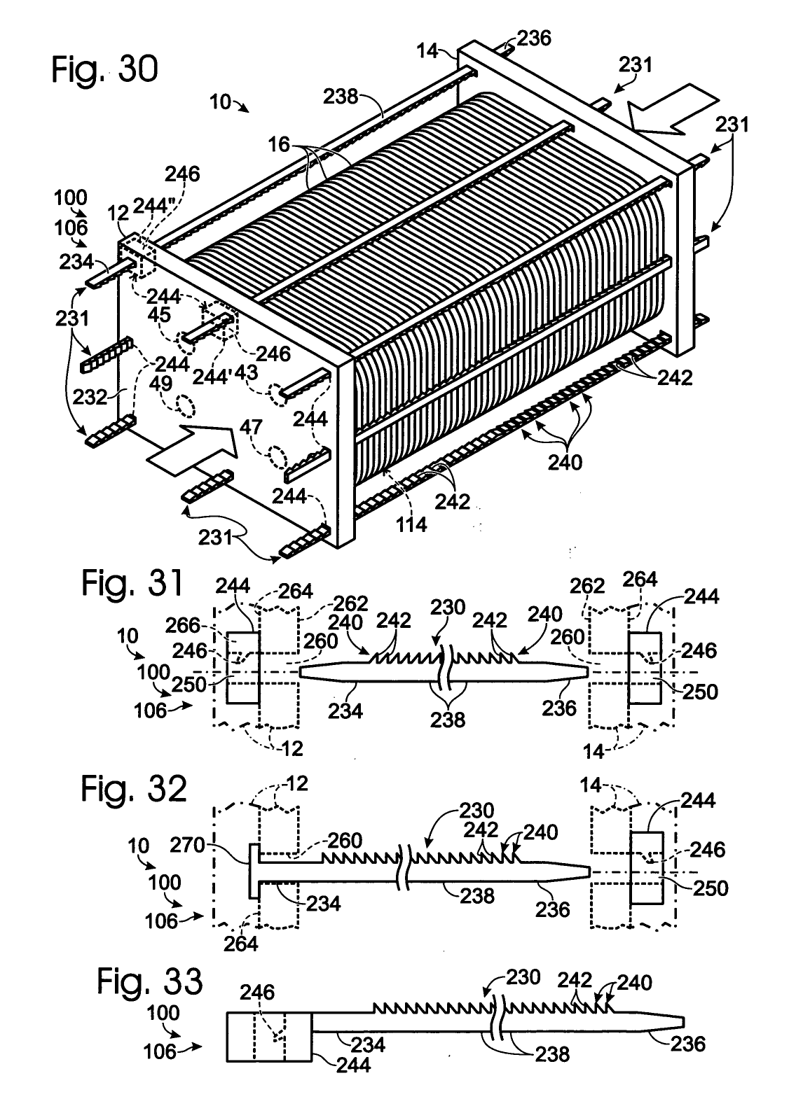

Another illustrative example of a fuel cell stack 10 with a stack compression system 100 according to the present disclosure is shown in FIG. 30. As illustrated, the compression system includes a plurality of spaced-apart segments 231, which interconnect the end plates 12 and 14 of the fuel cell stack and maintain compression applied between the end plates. Accordingly, the segments are adapted to apply and/or maintain sealing compression to the fuel cells 16 that are supported between the end plates. Compression systems 100 that include a plurality of segments 231 may (but are not required to be) referred to herein as segmented compression systems, or segmented stack compression systems, 106. Similar to the other (stack) compression systems 100 described, illustrated and/or incorporated herein, segmented compression systems 106 according to the present disclosure may be referred to as compression systems that do not require tie rods to provide the necessary compression of the fuel cells between the end plates of the stack with which the compression systems are used.

The segmented compression mechanisms discussed herein may be utilized with the fuel cells, end plates, fuel cell stacks, and fuel cell systems described, illustrated, and/or incorporated herein, such as in the context of the previously described banded and/or framed compression systems. Accordingly, and as discussed previously, the illustrated fuel cell stack configuration shown in FIG. 30 is intended merely to be an illustrative, partially schematic example. Segmented compression systems 106 may be used with any suitable fuel cell and/or end plate configuration and may include any desired number of fuel cells. In FIG. 30, end plate 12 is shown including schematically illustrated input and outlet ports 43, 45, 47, and 49. As discussed previously, it is within the scope of the present disclosure that the location and number of input and outlet ports for a particular fuel cell stack may vary without departing from the scope of the present disclosure. Furthermore, the fuel cell stack may, but is not required to, include an integrated humidification region, as graphically indicated in dashed lines at 114. Segmented compression systems 106, as well as others of the compression systems described, illustrated and/or incorporated herein, may additionally or alternatively be used with fuel cell stacks that include end plates having non-planar (uncompressed and/or compressed) configurations. For example, segmented compression systems 106 also may be utilized with parabolic or other shaped non-planar end plates, which may be pressed flat during assembly of the fuel cell stack.

In the illustrative example, eight segments 231 are shown spaced apart around a perimeter region 232 of the end plates, with the segments extending external to the perimeter of the fuel cells 16 within the stack. Segments 231 are adapted to maintain the end plates (and fuel cells 16 supported between the end plates) in compression in the direction indicated with arrows in FIG. 30. It is within the scope of the present disclosure that the number, spacing, and orientation (relative to the fuel cells) of the segments may vary without departing from the scope of the present disclosure. For example, a fewer or greater number of segments may be used. Furthermore, the segments may be spaced around the perimeter region of the end plates in any suitable spacing and configuration, including evenly and unevenly spaced configurations. For example, in some embodiments it may be desirable to more closely space the segments near certain portions of the perimeter region of the end plates, such as portions where additional compressive forces are desired, portions where the end plates have less support and/or resistance to displacement, portions where there are greater forces from within the stack to urge the end plates away from each other, etc. It is also within the scope of the present disclosure that the segments may be configured to individually provide different amounts of compression to the stack.

Segments 231 include opposed end regions 234 and 236 that are separated by a spanning member, or region, 238. The end regions may be described, in at least some embodiments, as being sizing regions, or insertion regions, of the segments in that the end regions are inserted into the subsequently discussed lock assemblies to define the compression applied and/or maintained by segment 231. Spanning member 238 typically will be sized to be at least substantially as long as the distance between the end plates of a fuel cell stack. Accordingly, the minimum suitable length for a spanning member 238, and/or complete segment 231, according to the present disclosure will be at least partially defined by the distance between the end plates of a fuel cell stack with which the segment is to be used. In some embodiments, the spanning member will be at least as long as the distance between the end plates. Segments 231 may be formed from any suitable material sufficient to apply and/or maintain the desired compression to the fuel cell stack and which are suitable for use in the operating environment and conditions encountered during operation of the associated fuel cell stack. It is within the scope of the present disclosure that segments 231 may be formed from one or more of metal and plastic. It is within the scope of the present disclosure that segments 231 may be rigid or flexible. Although illustrated in FIG. 30 extending in only linear configurations between the end plates, it is within the scope of the present disclosure that segments 231 may define closed loops that interconnect and extend between the end plates, such as with the end regions of one or more segments being interconnected to form the closed loop.

As discussed in more detail herein, each segment 231 further includes a plurality of sequentially spaced-apart teeth, or engagement members, 240 that include engagement surfaces 242 that are oriented to be selectively engaged by a pawl, detent, or other suitable lock member 246 of a lock assembly 244. As illustrated, the teeth include engagement surfaces 242 that define planes that extend transverse to the long axis of the spanning member of the segment. Teeth 240 may also, but are not required to, be referred to as defining stria or stops. The plurality of spaced-apart teeth may be, but are not required in all embodiments to be, referred to as a gear rack that is integrated into the segment. The lock assembly may also be referred to as a retainer, a securement member, and/or as a ratcheting lock assembly.

In the illustrated example shown in FIG. 30, teeth 240 extend along the end regions 234 and 236, as well as spanning member 238. It is within the scope of the present disclosure that teeth 240 may extend along only portions of the segments, such as the end regions, and/or that the segments may include regions that do not include teeth extending there along. As illustrative, non-exclusive examples, the teeth may extend along less than 25% of one side, or surface, of the segment, or they may extend along a greater extent of the segment, such as at least 25%, at least 50%, at least 75%, or more, of the length of the segment. As illustrated, the teeth extend along one side of each of the segments, with the other sides of the segments being smooth or otherwise free from teeth. It is within the scope of the present disclosure that the segments may include teeth 242 on more than one of the segment's sides, but the teeth will still define generally parallel, sequentially spaced engagement surfaces. It is within the scope of the present disclosure that at least one, and optionally two or more, of the sides of the segment may be free of teeth of other projecting members that are adapted to be sequentially engaged by the lock member of the lock assemblies during use of the segmented compression system.

Lock assemblies 244 are adapted to receive at least an end region 234 of a segment 231 therethrough, with the lock assembly being adapted to permit insertion of the end region therethrough in one direction while restricting withdrawal of the end region in an opposed, or opposite, direction. Therefore, unlike a nut that threadingly engages an end region of a bolt or similar tie rod and which may be threaded or unthreaded to reposition the nut along the length of the tie rod, lock assemblies 244 are adapted to permit insertion, including further insertion, of an end region of a segment therethrough, but to restrict withdrawal of the end region after it has been inserted through the lock assembly. As indicated somewhat schematically in FIG. 30, it is within the scope of the present disclosure that lock assemblies 244 may be positioned external the end plates, such as indicated at 244′ on the exterior surface (i.e., the surface that faces generally away from fuel cells 16) of end plate 12. As indicated at 244″ in FIG. 30, it is also within the scope of the present disclosure that the lock assemblies may be inserted into, integrally formed in, and/or otherwise coupled to the end plate.

In FIG. 31, the illustrative, non-exclusive example of a suitable construction for segments 231 and lock assemblies 244 for use in segmented compression systems 106 according to the present disclosure are shown in more detail. As shown, each lock assembly 244 defines a passage, or channel, 250 that is sized to permit at least an end region, and optionally at least a portion of the spanning member, to extend therethrough. Also shown in FIG. 31 is a lock member 246 that extends into channel 250 and is positioned to sequentially engage the engagement surfaces 242 of teeth 240 as the segment is inserted through the passage. Channel 250 may also be, but is not required in all embodiments to be, referred to as an aperture, slot, or passage that is sized to permit at least the end region of a segment to extend therethrough such that the corresponding teeth of the segment may be selectively and sequentially engaged by the lock member of the lock assembly. Lock member 246 may also be (but is not required in all embodiments to be) described as a ratcheting member, or mechanism. Similarly, segments 231 may additionally or alternatively be described as being ratcheting one-directionally adjustable securing members.

As illustrated, the lock member and teeth are cooperatively oriented relative to each other so that the segment may be inserted into and through the channel in one direction, with the lock member deflecting away from the teeth that it engages so that further insertion of the segment through the channel is not restricted. Accordingly, lock member 246, which may also be referred to as a detent or pawl, should be adapted to deflect or otherwise resiliently be urged away from the position shown in FIG. 31 to provide sufficient clearance for the segment to be further inserted through the channel in this permitted, or insertion, direction. However, when the segment is urged in a reverse direction, such as to withdraw the segment back through the channel, the lock member is adapted to engage the engagement surface of a tooth, such as the last tooth to pass beyond the pawl, and thereby restrict withdrawal of the segment in this direction, which may be referred to as a restricted direction.

Because the lock assembly is adapted to restrict removal of the sizing region after it has been inserted through the channel of the lock assembly (or otherwise prevented from being withdrawn through the channel by the lock member), the length of the spanning member is defined, at least in part, by the extent to which the sizing region is inserted through the channel of the lock assembly. Accordingly, the operative length of the spanning member may be shortened by drawing more of the sizing region through the channel in the lock assembly, but the length is restricted from being increased by the lock member restricting withdrawal of the sizing region through the channel in the locking assembly. Because a plurality of segments are utilized, the compression applied to one region of the stack may be adjusted independent of other regions of the stack. By adjusting the individual compression provided by the segments and/or the spacing and/or number and/or construction of the segments being utilized, the amount of compression being applied to the fuel cell stack may be adjusted. Similarly, the amount of compression to be applied may be adjusted by selectively further inserting the sizing member of a segment into the channel of the lock assembly of a segment.

In FIG. 31, the teeth on and/or proximate to one end region of the segment are oppositely oriented relative to the teeth on and/or proximate to the other end region of the segment. This construction is not required to all embodiments. In the illustrative example shown in FIG. 31, the teeth project from one side, or surface, of the segment. It is within the scope of the present disclosure that the segments may include sidewalls or other suitable guides that extend along the lateral edges of the teeth. Similarly, it is within the scope of the present disclosure that the orientation, size, number, and/or spacing of the teeth on the segment and/or relative to the end regions of the segment may vary from the illustrative, non-exclusive example shown in FIG. 31.

Additional examples of suitable constructions for segments 231 according to the present disclosure include constructions utilized with cable, or “zip,” ties that are conventionally utilized to organize cables and wires by defining a closed perimeter within which the cables extend. Illustrative, non-exclusive examples of cable ties are disclosed in U.S. Pat. Nos. 3,186,047, 6,235,987, and 6,484,366, the complete disclosures of which are hereby incorporated by reference for all purposes. It is within the scope of the present disclosure that segments 231 may include lock assemblies that are secured to, and/or integrally formed with, an end region of the spanning member distal the sizing region.

As discussed, the lock assemblies may be separate structures that are coupled to opposed regions of the segments external of the end plates. This is graphically depicted in FIG. 31 in dashed lines, with the end plates 12 and 14 being illustrated defining apertures 260 through which at least the end regions of the segments may extend from an internal surface 262 of the end plate to an external surface 264 of the end plate and through the channel in lock assembly 244. As also discussed, the lock assemblies may be inserted into and/or integrated into the end plates, such as is schematically illustrated in dash-dot lines in FIG. 31. It is further within the scope of the present disclosure that the lock assemblies may be integrally formed in the end plates. As an illustrative, non-exclusive example of this latter variant, the end plates and lock assemblies may be molded from a suitable metal and/or plastic material.

During installation of a fuel cell stack 10 that utilizes a segmented compression system 106, the fuel cell stack may be compressed in a press, vice, or similar compression mechanism that applies at least the desired amount of compression, and in some embodiments applies greater than the desired, or threshold, amount of compression to the fuel cell stack. This compression is applied between the end plates, such as in the direction indicated with arrows in FIG. 30. By utilizing an external device to position and/or sufficiently compress the components of the fuel cell stack, the stack is retained in a desired orientation during installation of the segments. After installation of the segments, which collectively are adapted to maintain at least the threshold amount of compression to the fuel cell stack, the stack may be removed from the vice or other external compression mechanism.

This methodology allows for stack compression, without the use of heavy and labor intensive tie rods. Accordingly, the fuel cell stack may be assembled and compressed externally (i.e. in a press, vice, or similar mechanism that retains the stack in compression) while the segments or other alternative compression systems, such as the previously discussed banded compression systems, are secured in a desired orientation. Upon securement or other installation and/or positioning of the segments and/or alternative compression mechanisms, the fuel cell stack is removed from the press, vice, or other structure that was utilized to apply the necessary compression to the stack during assembly, but not use, of the stack. These compression methodologies are not required to all embodiments, and it is within the scope of the present disclosure that any suitable process may be used to assemble fuel cell stacks 10 with stack compression systems 100 according to the present disclosure.

When it is desired to remove one or more of the segments of a segmented compression system according to the present disclosure, the desired segment may be cut or otherwise severed. When the segments are utilized with separate lock assemblies, including lock assemblies that are integrated with end plates of the stack, the separated portions of the segments may thereafter be further inserted through the corresponding lock assembly until the portion has been completely inserted through the lock assembly. While not required, the lock assembly (and, in some embodiments, the associated end plate) may thereafter be reused. It is also within the scope of the present disclosure that the lock assemblies may include a release mechanism that, when actuated, is adapted to permit withdrawal of the segment in the restricted direction through the channel in the lock assembly. In such a construction, the release mechanism, and/or corresponding lock member, is biased to a position where the lock member is positioned to engage the engagement surface of a tooth that is inserted into the channel of the lock assembly to restrict withdrawal of the segment therethrough. A release mechanism is graphically and schematically indicated at 266 in FIG. 31 and may have any suitable construction. An illustrative, non-exclusive example is a resilient lever that is coupled to the lock member and adapted to draw the lock member generally away from the channel in the lock assembly. Additional examples are illustrated in the incorporated patents that demonstrate cable tie constructions.

In a further variation of the illustrative segment constructions described above, a segment 231 may include (or be coupled to) a head, or anchor, region that is adapted to be engaged with or otherwise secured to an end plate of a fuel cell stack. For example, the anchor may engage an exterior surface of the end plate distal the fuel cells and/or be received by a suitable mount therein or thereupon. In such a construction, the spanning member may extend from that end plate to the other end plate, where a sizing region of the segment is received into a lock assembly, such as may be positioned on an exterior surface of the end plate, formed in the end plate, secured to the end plate, etc. An illustrative, non-exclusive example of a segmented compression system 106 having such a construction is shown in FIG. 32. As illustrated, segment 231 is shown including an anchor 270 at one end region, such as end region 234. The anchor is sized to engage external surface 264 of an end plate, such as end plate 12, with the anchor being sized so that it will not pass through the aperture 260 in the end plate. In such a construction, the segment is first received through the aperture in the first end plate, with the (sizing) end region of the segment distal the anchor, such as end region 236 being inserted through a channel in a lock assembly 244 associated with the other end plate of the stack, such as end plate 14. As indicated in dashed and dash-dot lines in FIG. 31, and as previously discussed, it is within the scope of the present disclosure that the lock assembly may be a separate structure from the end plate and/or that it may be integrated with or otherwise inserted into the end plate. It is further within the scope of the present disclosure that the anchor may be integrated into an end plate, such as indicated somewhat schematically in dash-dot lines in connection with end plate 12.

FIG. 33 provides another illustrative non-exclusive example of another suitable construction for segmented compression systems 106 according to the present disclosure. As shown, the compression system includes a segment 231 that is coupled to a lock assembly 244 at one end region, such as end region 234. The other end region 236 of the segment, namely, the end region distal the lock assembly, may be referred to as the sizing region of the segment and is adapted to be inserted into a lock assembly. In some embodiments, the sizing region may be inserted into the lock assembly at the other end of the segment, such as to form a closed loop that extends though apertures or other guides in the opposed end plates of the stack. In such an embodiment, the sizing region of the segment will typically be at least twice as long as the distance between the end plates of the corresponding fuel cell stack. As a variation of this construction, two or more segments may be interconnected together to form this closed loop, with the sizing region of the segments being inserted into the lock assemblies of another of the (or the other of the) segments. In a further variation of this construction, two or more segments may be used in place of the bands described above in connection with banded compression systems 102.

### INDUSTRIAL APPLICABILITY

The fuel cell stacks and stack compression systems disclosed herein are applicable to the energy-production industries, and more particularly to the fuel cell industries.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

I claim:

1. A fuel cell stack, comprising:
a pair of end plates;
a plurality of fuel cells supported between the end plates;
a stack compression system adapted to maintain compression of the fuel cells between the end plates in a direction extending generally between the end plates, wherein the stack compression system is free from rigid tie rods that extend between the end plates to apply compression to the fuel cells by drawing the end plates together.

2. The fuel cell stack of claim 1, wherein the compression system is further adapted to urge the end plates toward each other to apply compression to the plurality of fuel cells that are supported between the end plates.

3. The fuel cell stack of claim 1, wherein the stack compression system includes a strap assembly that includes at least one compressive band that extends around the end plates of the fuel cell stack to apply compression to the fuel cell stack.

4. The fuel cell stack of claim 3, wherein the compressive band forms a closed loop that extends around the end plates and the plurality of fuel cells.

5. The fuel cell stack of claim 3, wherein the compression system further includes a biasing member that is adapted to bias the end plates toward each other.

6. The fuel cell stack of claim 3, wherein the compressive band includes end regions, and further wherein the compression system includes a fastening mechanism that is adapted to secure the end regions together.

7. The fuel cell stack of claim 3, wherein the compression system further includes force directing structure that is adapted to distribute compressive forces applied by the strap assembly to the end plates.

8. The fuel cell stack of claim 7, wherein the end plates include perimeter regions, wherein the force directing structure is adapted to distribute compressive force applied by the strap assembly to a central region of the end plates, and further wherein the strap assembly is adapted to apply more compressive force to the force directing structure than it applies to the perimeter regions of the end plates.

9. The fuel cell stack of claim 3, wherein the strap assembly includes a plurality of compressive bands that extend around the end plates of the fuel cell stack, and further wherein the plurality of compressive bands include at least two spaced-apart bands.

10. The fuel cell stack of claim 3, wherein the strap assembly includes a plurality of compressive bands that extend around the end plates of the fuel cell stack, and further wherein the plurality of compressive bands include at least two intersecting bands.

11. The fuel cell stack of claim 1, wherein the compression system includes a frame that surrounds the plurality of fuel cells on at least four sides to define a compartment into which the fuel cells and at least one of the end plates is received, wherein the frame includes a pair of end walls and at least two side walls extending between the end walls.

12. The fuel cell stack of claim 11, wherein the frame further surrounds the end plates.

13. The fuel cell stack of claim 11, wherein at least one of the end plates forms a portion of the frame.

14. The fuel cell stack of claim 13, wherein the compression system further includes at least one compression member that is adapted to extend from an end wall of the frame to urge an end plate of the fuel cell stack toward the other end wall of the frame.

15. The fuel cell stack of claim 14, wherein the compression system includes a plurality of individually adjustable compression members.

16. The fuel cell stack of claim 15, wherein the compression system further includes at least one engagement member that is adapted to distribute forces applied by the at least one compression member to the end plate of the fuel cell stack.

17. The fuel cell stack of claim 13, wherein the compression system further includes at least one adjustable compression mechanism that extends generally between an end wall of the frame and an end plate of the fuel cell stack.

18. The fuel cell stack of claim 17, wherein the adjustable compression mechanism is adapted to automatically apply compression to the fuel cell stack upon insertion of the fuel cell stack into the compartment.

19. The fuel cell stack of claim 17, wherein the adjustable compression mechanism includes at least one lever-actuated member that is adapted to be selectively pivoted between a range of positions to adjust the magnitude of the compressive force applied to the fuel cell stack.

20. The fuel cell stack of claim 1, wherein the compression system includes a plurality of segments that are sized to extend between the end plates, wherein the compression system includes, for each of plurality of segments, at least one ratcheting lock assembly that is adapted to secure the segment relative to one of the end plates of the fuel cell stack, and further wherein each segment includes a spanning member having a pair of opposed end regions and a plurality of sequentially spaced teeth.

21. The fuel cell stack of claim 20, wherein the segments are flexible segments.

22. The fuel cell stack of claim 20, wherein the segments are formed from plastic.

23. The fuel cell stack of claim 20, wherein at least one of the plurality of segments includes an end region having an anchor adapted to engage an exterior surface of one of the pair of end plates.

24. The fuel cell stack of claim 20, wherein at least one of the plurality of segments includes an integrally formed lock assembly.

25. The fuel cell stack of claim 20, wherein the lock assembly includes a lock member adapted to sequentially engage the plurality of teeth.

26. The fuel cell stack of claim 20, wherein the lock assembly defines a channel through which at least an end region of the segments is adapted to be inserted to urge the teeth into sequential engagement with a lock member, and further wherein the lock member is adapted to permit insertion of the segment through the channel in one direction while restricting withdrawal of the segment from the channel in an opposite direction.

27. The fuel cell stack of claim 26, wherein the lock member is a ratcheting lock member that is adapted to selectively engage engagement surfaces on the plurality of teeth.

28. The fuel cell stack of claim 20, wherein at least one of the lock assemblies is integrated with one of the end plates of the fuel cell stack.

29. The fuel cell stack of claim 20, wherein at least one of the lock assemblies is inserted into an end plate of the fuel cell stack.

30. The fuel cell stack of claim 1, wherein the plurality of fuel cells are proton exchange membrane fuel cells.

31. The fuel cell stack of claim 1, wherein the fuel cell stack includes at least one input port adapted to receive a flow of hydrogen gas and at least one input port adapted to receive an oxygen-containing stream, and further in combination with a hydrogen generation assembly that is adapted to produce the flow of hydrogen gas.

32. The fuel cell stack of claim 1, wherein the fuel cell stack has a rated power output that is greater than 1 kilowatt.

33. The fuel cell stack of claim 1, wherein the fuel cell stack has a rated power output that is less than 1 kilowatt.

34. The fuel cell stack of claim 1, in combination with at least one energy-consuming device that is electrically coupled to the fuel cell stack, and further wherein the fuel cell stack is adapted to satisfy a load applied by the at least one energy-consuming device.
